(19) United States
(12) Patent Application Publication
(10) Pub. No.: US 2015/0345678 A1
(43) Pub. Date: Dec. 3, 2015

(54) ADJUSTABLE ANGLE PIPE FITTING

(71) Applicant: NATIONAL DIVERSIFIED SALES, INC., Fresno, CA (US)

(72) Inventors: Daniel Nourian, Reedley, CA (US); David Rusch, Springville, CA (US); Dustin Storm, Clovis, CA (US); Mark Fynaut, Madera, CA (US)

(73) Assignee: NATIONAL DIVERSIFIED SALES, INC., Woodland Hills, CA (US)

(21) Appl. No.: 14/292,738

(22) Filed: May 30, 2014

(51) Int. Cl. F16L 27/08; F16L 23/04; F16L 47/14; F16L 23/16

(52) U.S. Cl. CPC F16L 27/0804; F16L 23/162; F16L 23/04; F16L 47/14

(57) ABSTRACT

An angled joint for insertion into a pipe system comprising a first conduit having a first elongate axis and being configured to terminate in a planar section that is angled at 45 degrees to the first elongate axis, the planar section including a continuous circumferential first flange that extends outwardly from the first conduit; a second conduit having a second elongate axis and being configured to terminate in a planar section that is angled at 45 degrees to the second elongate axis, the planar section including a continuous circumferential second flange that extends outwardly from the second conduit; a first clasp and second clasp that extends in a semi-annular configuration, and terminating in a male detent on a first end and a female detent on a second end.

### BACKGROUND

The present invention relates to moving fluids from one place to another in pipes and conduits. More particularly, the application relates to a system and method for creating angled joints in pipes that are required to assume complex and non-uniform configurations.

Moving water under, or across, the ground is a major aspect of nearly every building project, gardening project, or landscaping project. Building contractors typically lay pipes configured for moving water from one point to another, whether it be from a storm downpipe to a sump, or across a waterlogged lawn to a drain, moving water in pipes is a major industry.

Typically today, water is moved in pipes which are made from a plastic or polymer compound such as PVC. Such pipes are connected together using joints that are glued or otherwise attached to the ends of the pipes. Some joints are shaped to produce an angle in the flow of the water. The most common angle that joints are shaped to possess is a deflection angle of 90 degrees, but joints with a deflection of 45 degrees are also known, and sometimes joints with a deflection of 22.5 degrees, or 67.5 degrees are manufactured. (A deflection angle is not the angle displayed by the joint itself, but the angle that water is deflected from following a straight line. So, for example, a joint with a deflection angle of 22.5 degrees will itself display an angle of 157.5 degrees.)

A problem that arises in the art of pipe joints, is that joints of only a few specific deflection angles are manufactured. A shopper at a hardware store will be fortunate if she can find angled joints having the four different deflection angles mentioned above, namely 22.5 degrees, 45 degrees, 67.5 degrees, and 90 degrees. However, a user frequently requires to lay a pipe system having a unique angle that lies in between the angles that are available off the shelf. The inability to have ready access to such non-standard angled joints frequently leads to complex and expensive workarounds.

There is thus a need to provide a system and method that addresses the problems in the prior art. The present invention addresses these and other problems.

### SUMMARY OF THE INVENTION

The present invention, in one embodiment, is an angled joint for insertion into a pipe system. The system comprises a first conduit having a first elongate axis and being configured to terminate in a planar section that is angled at 45 degrees to the first elongate axis, the planar section including a continuous circumferential first flange that extends outwardly from the first conduit. A second conduit is provided, having a second elongate axis and being configured to terminate in a planar section that is angled at 45 degrees to the second elongate axis, the planar section including a continuous circumferential second flange that extends outwardly from the second conduit. A first clasp is provided that extends in a semi-annular configuration, and terminates in a first type detent on a first end and a second type detent on a second end, the first clasp having a sectional shape that defines a first channel extending along an inner surface of the first clasp. A second clasp is provided that extends in a semi-annular configuration, and terminates in a first type detent on a third end and a second type detent on a fourth end, the second clasp having a sectional shape that defines a second channel extending along an inner surface of the second clasp. Under this configuration, the first flange is placed adjacent the second flange. The first channel receives a portion of the first flange and a portion of the second flange. The second channel receives a portion of the first flange and a portion of the second flange. The second type detent of the first clasp receives the first type detent of the second clasp, and the second type detent of the second clasp receives the first type detent of the first clasp. Under these conditions, an angled joint for insertion into a pipe system is provided.

In some embodiments, the first type detent on each clasp has at least a first tooth and a second tooth and the second type detent on each clasp has at least a first tooth and a second tooth. When the first tooth of each first type detent engages the first tooth of each second type detent, then the first clasp and the second clasp together form an annulus having a first circumference. The first tooth of each first type detent engages the second tooth of each second type detent, then the first clasp and the second clasp together form an annulus having a second circumference that it smaller than the first circumference. This feature allows the user to start with the angled joint in a condition wherein it is possible to rotate the first and second conduits about each other when the clasps have the first diameter. But when the clasps are in the second diameter, the first and second conduits are more securely attached to each other to provide a better seal between the flanges.

In another embodiment, the first type detent on each clasp has a first male tooth and a first female receiver and the second type detent on each clasp has a second male tooth and a second female receiver. When the first male tooth of each first type detent engages the second female receiver of each second type detent, then the first clasp and the second clasp together form an annulus having a first circumference. When the second male tooth of each second type detent engages the first female receiver of each first type detent, then the first clasp and the second clasp together form an annulus having a second circumference that it smaller than the first circumference.

In some embodiments, the first channel and the second channel each have side surfaces that define an internal taper. Preferably, the taper has an internal angle of between 1 degree and 10 degrees. Further, in some embodiments, the first flange and the second flange are configured such that, when the first flange and the second flange are placed in contact with each other, then opposite external surfaces of the flanges form an external taper. Preferably, the taper of the joined flanges has an external angle of between 1 degree and 10 degrees, to match the internal taper of the channels.

In another embodiment, the invention is a kit for forming an angled joint for insertion into a pipe system. The kit comprises a first conduit having a first elongate axis and being configured to terminate in a planar section that is angled at 45 degrees to the first elongate axis, the planar section including a continuous circumferential first flange that extends outwardly from the first conduit. A second conduit is provided, having a second elongate axis and being configured to terminate in a planar section that is angled at 45 degrees to the second elongate axis, the planar section including a continuous circumferential second flange that extends outwardly from the second conduit. A first clasp is provided that extends in a semi-annular configuration, and terminating in a first type detent on a first end and a second type detent on a second end, the first clasp having a sectional shape that defines a first channel extending along an inner surface of the first clasp. A second clasp is provided that extends in a semi-annular configuration, and terminating in a first type detent on a third end and a second type detent on a fourth end, the second clasp having a sectional shape that defines a second channel extending along an inner surface of the second clasp. The first flange is sized to be placed adjacent the second flange such that the first flange and second flange are in contact with each other along a full circular circumference. The first channel is configured to receive a portion of the first flange and a portion of the second flange. The second channel is configured to receive a portion of the first flange and a portion of the second flange. The second type detent of the first clasp is configured to receive the first type detent of the second clasp, and the second type detent of the second clasp is configured to receive the first type detent of the first clasp.

In some embodiments, the first type detent on each clasp has at least a first tooth and a second tooth and the second type detent on each clasp has at least a first tooth and a second tooth. When the first tooth of each first type detent engages the first tooth of each second type detent, then the first clasp and the second clasp together form an annulus having a first circumference. When the first tooth of each first type detent engages the second tooth of each second type detent, then the first clasp and the second clasp together form an annulus having a second circumference that it smaller than the first circumference. In other embodiments, the first type detent on each clasp has a first male tooth and a first female receiver and the second type detent on each clasp has a second male tooth and a second female receiver. When the first male tooth of each first type detent engages the second female receiver of each second type detent, then the first clasp and the second clasp together form an annulus having a first circumference. When the second male tooth of each second type detent engages the first female receiver of each first type detent, then the first clasp and the second clasp together form an annulus having a second circumference that it smaller than the first circumference. Preferably, the first channel and the second channel each have side surfaces that define an internal taper, that has an internal angle of between 1 degree and 10 degrees. Further, the first flange and the second flange are configured such that, when the first flange and the second flange are placed in contact with each other, then opposite external surfaces of the flanges form an external taper, that preferably has an angle of between 1 degree and 10 degrees.

These and other advantages will become apparent when understood in conjunction with the description of the drawings and the preferred embodiments.

### BRIEF DESCRIPTION OF THE DRAWINGS

FIG. 1 is a perspective view of an angled joint having features of the invention.

FIG. 2 is a perspective view, partly disassembled, of the angled joint of FIG. 1.

FIG. 3 is a front side elevational view of the angled joint shown in FIG. 1.

FIG. 4 is bottom view of the angled joint shown in FIG. 1.

FIG. 5 is a left side elevational view of the angled joint shown in FIG. 1.

FIG. 6 is a detailed sectional view of the detail identified in FIG. 4.

FIG. 7A is a perspective view of components of the angled joint of FIG. 1, shown in exploded view.

FIG. 7B is a perspective view of components of another embodiment of an angled joint, shown in connected condition.

FIGS. 8A-8D are perspective views of the angled joint of FIG. 1, shown in different conditions in which a deflection angle is changed.

FIG. 9 is a perspective view, further partly disassembled, of the angled joint of FIG. 1.

FIG. 10 is a schematic view of a pipe system incorporating the angled joint of FIG. 1.

### DETAILED DESCRIPTION OF THE PREFERRED EMBODIMENTS

In some embodiments, the invention is a variable angle joint 10 for inserting into a pipe system to form a deflection angle for water flow in the pipe system. Preferably, the joint 10 may include only four separable components, namely: two mating conduit portions, that may be identical to each other, a first conduit 12 and a second conduit 14; and two mating clasps that may be identical to each other, namely a first clasp 16 and a second clasp 18. Each of these components may be made from molded plastic, or other polymer such as Poly Vinyl Chloride (PVC).

In some embodiments, the first and second conduits 12, 14 each define a central bore 20 to permit the flow of water through the conduit. The conduit has a diameter that is slightly smaller, or slightly larger, than pipe ends onto which the joint 10 will be connected, just sufficient to allow smooth passage of one into the other to allow glue or other adhesive that has been applied to into the overlapping sections to secure the connection between the pipes.

The first and second conduits each terminate on a plane that is set at an angle of 45 degrees to the elongate axes A-A and B-B of the respective conduits. See FIG. 3. The angled end 22 of each conduit is provided with an outwardly extending flange 24 that lies on a plane. The two conduits are configured to be positioned in relation to each other so that the flanges 24 abut into contact with each other, providing complete circumferential contact of the flanges.

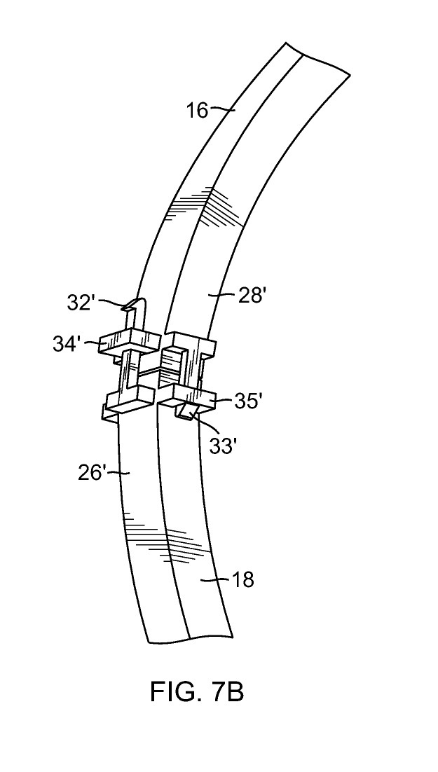

Two clasps are provided, a first clasp 16 and a second clasp 18. Each clasp follows a semi-circular path and terminates at opposite ends in a male detent 26 and a female detent 28. (FIG. 7A.) The detents have the general configuration of what is known in the art as a “tie.” As in a “tie,” each detent has a plurality of teeth that may continue to slip past each other until maximum tension is achieved. As seen in FIG. 7A, the male detent 26 has two teeth 32, and the female detent 28 also has two teeth 34. The two clasps may be fitted together so that male and female detents are placed in conjunction with one another, so that the teeth of the male detent may slip past the teeth of the female detent, until the maximum attainable tension in the clasps is present. A user may slip only the first of the male teeth past the first of the female teeth. At this point, the clasps have a first overall circumference. The user may then press the detents closer together so that the first of the male teeth engage the second of the female teeth. At this point, the clasps have a second overall circumference that is smaller than the first overall circumference. If there are three teeth, then a further movement of the detents will result in an even smaller circumference, etc. Upon the user releasing the detents after connection, they do not slip back in relation to each other.

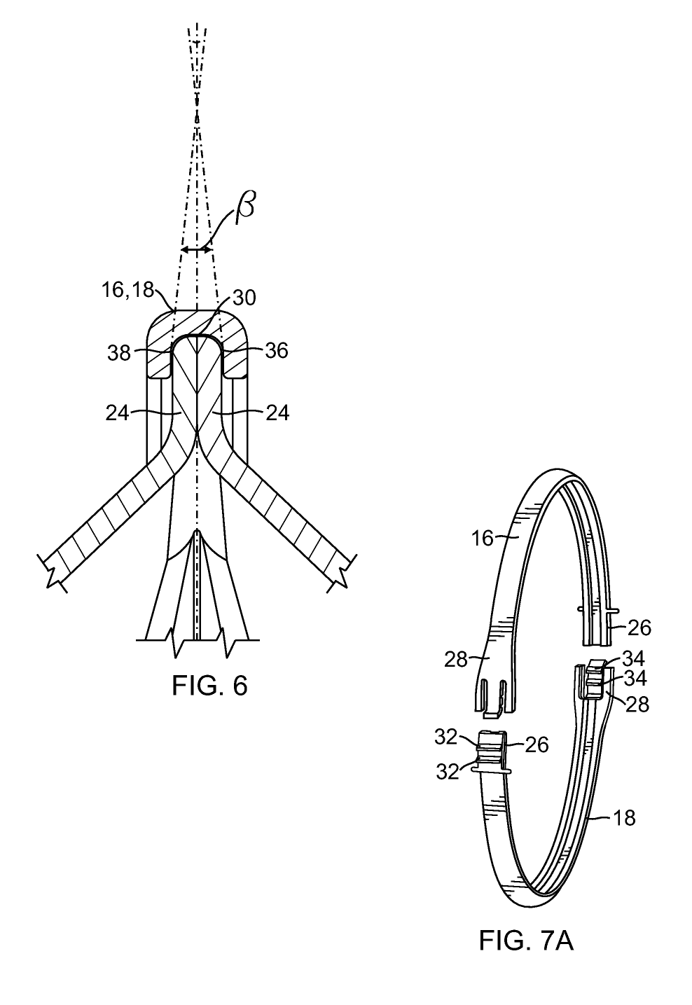

Each clasp 16, 18 defines, on an inner surface, the profile of a channel 30, as seen in sectional view in FIG. 6. The channel is sized to receive the width of two flanges 24 when the flanges are in contact with each other. The clasps have a circumference sized to receive the two flanges along the entire length of their circumference.

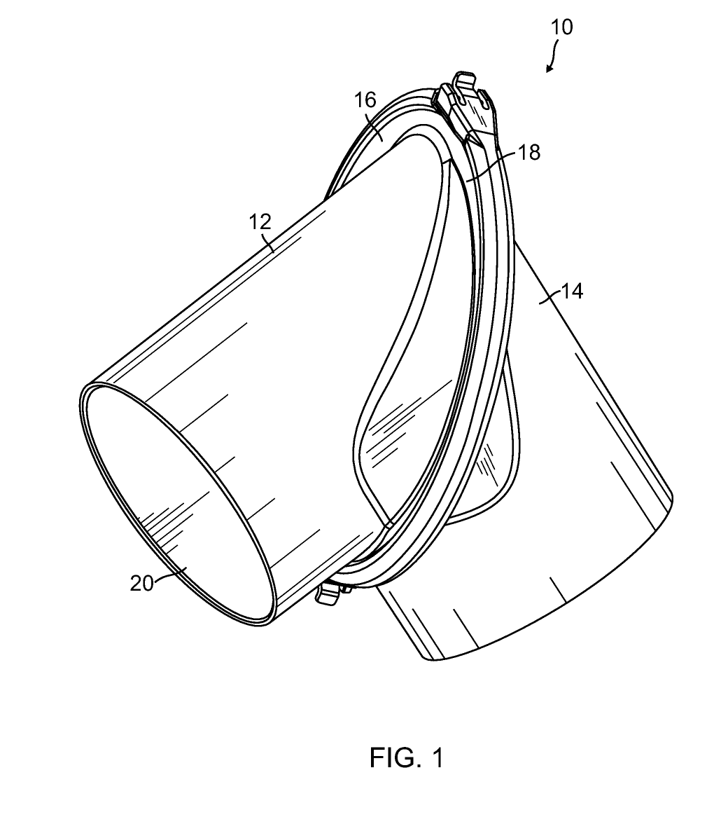

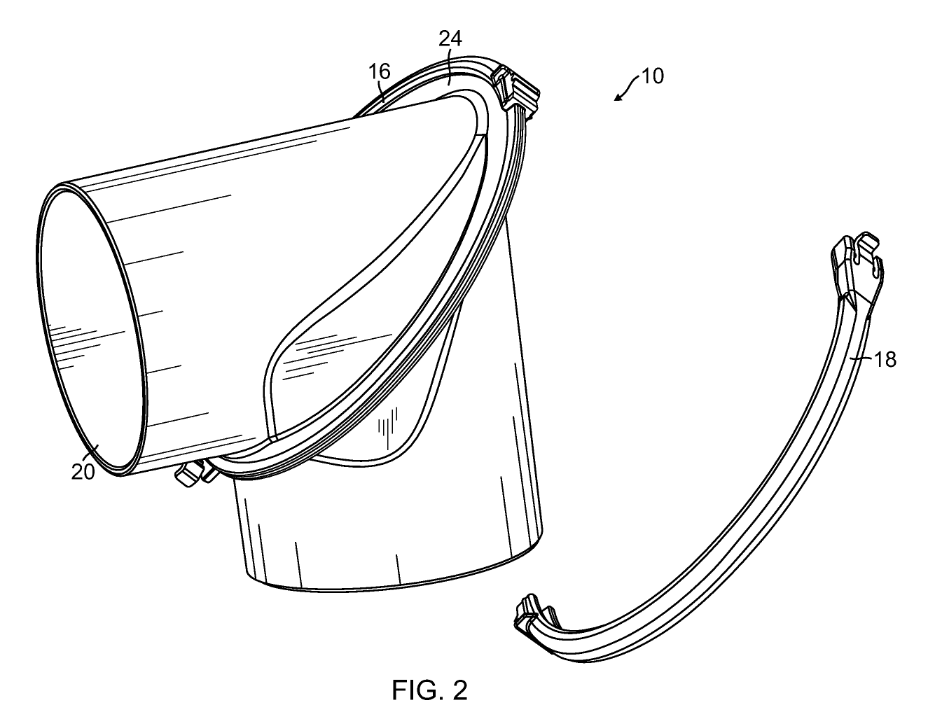

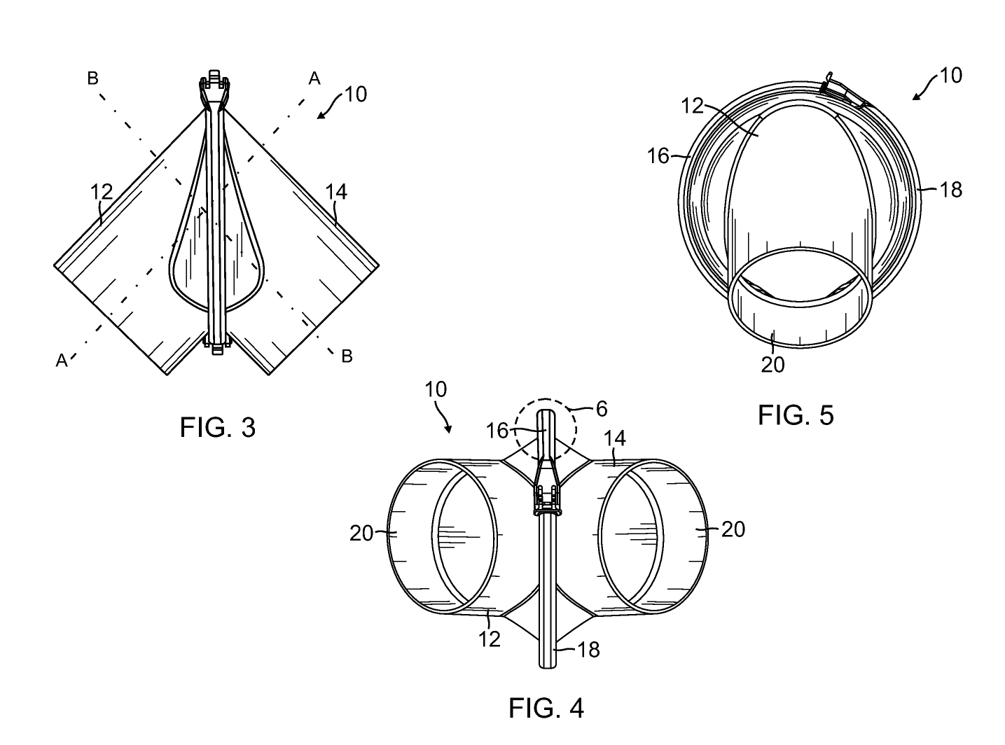

The joint is assembled by placing the first conduit 12 in contact with the second conduit 14 along the circumference of the flanges 24. The first clasp is then fitted around the edge of the two flanges (as in FIG. 2). Then, the second clasp is also fitted in the same way (FIG. 1). The male detents 26 of each clasp are inserted into the female detents 28 so that only the first tooth of each detent is engaged with the first tooth of the other, thereby providing the two clasps with the first overall circumference. This first overall circumference may be configured so that the two conduits 12, 14 are loosely held in contact with each other, and may be rotated while adjacent each other, but are securely held by the circumferentially arranged clasps so that the conduits do not come apart. It is in this condition that the joint 10 may be sold as a unit.

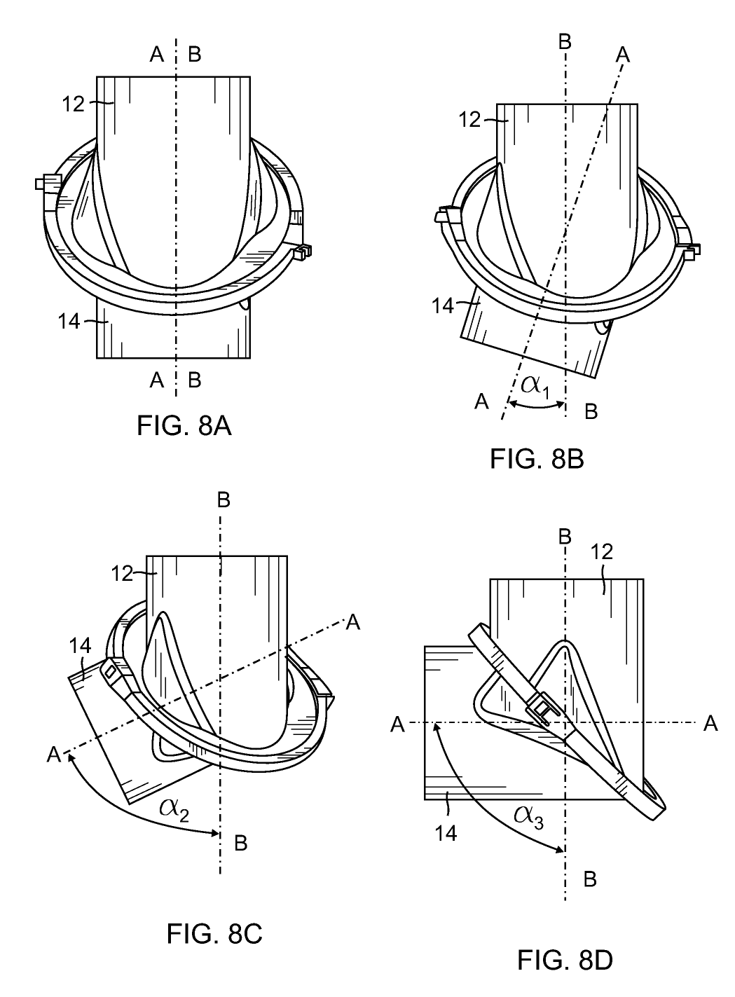

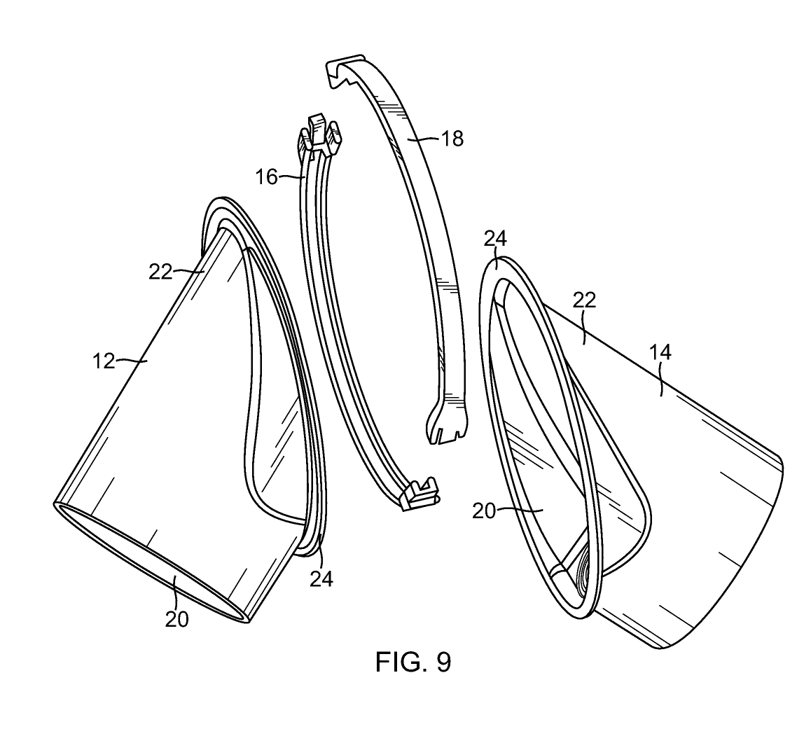

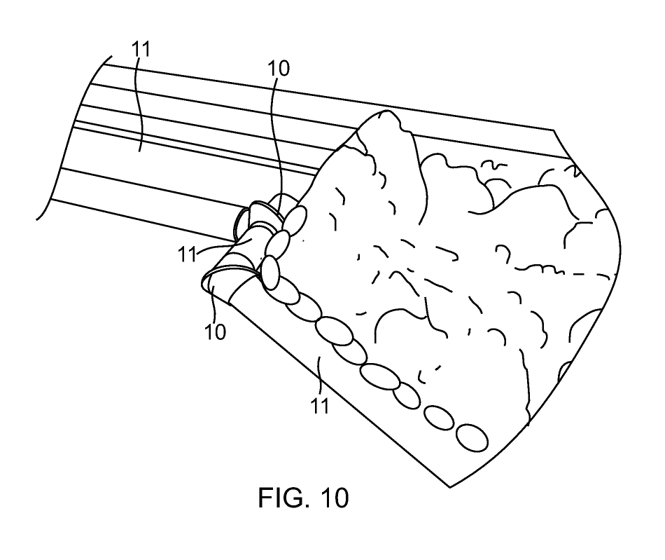

The user in the field may then use a joint 10 in the following way. The user may be confronted with a situation in which he is obliged to insert an angled joint into a pipe system 11, such as shown in FIG. 10. The user takes a joint 10 from his tool kit, and rotates the two conduits 12, 14 in relation to each other. As will be appreciated, the user may select any of the deflection angles (α1, α2, α3 etc.) shown in FIGS. 8A-8D, or any angle in between those shown. In fact, as will be appreciated, the user may select any deflection angle between 0 degrees and 90 degrees. Once the correct deflection angle is achieved, the user presses the two clasps 16, 18 more tightly together so that the first tooth of each male detent extends beyond the second tooth of each female detent (and the first tooth of each female detent extends beyond the second tooth of each male detent), thereby imparting the second overall circumference to the connected clasps which remains in a locked condition. The second overall circumference may be selected to that the clasps force the flanges tightly together to provide a water proof seal. In this regard, a slight taper (shown by angle β in FIG. 6) may be given to the side walls of the internal channel 30 of the clasps, and a matching taper may be given to the outer walls of the flanges 24, so that reduction in the circumference in the clasps from the first to the second overall circumference imparts a slight inward force vector that forces the flanges 24 towards each other. This effect enhances the water tight seal between the conduits. It will be readily understood that the detents may be supplied with more than two teeth, but that the logic of the system will simply be extended to allow the user to push the first tooth of the male detent beyond the third tooth of the female detent, and so on.

Once the user has a joint 10 that has the desired deflection angle tightly set by the clasps, the user may insert the terminal ends of pipes 11 (see FIG. 10) into the bores 20 of each conduit, and apply adhesive as needed. (Of course, in an alternative, the inner diameter of the pipes may be dimensioned to receive the outer diameter of conduits, but the principle of connection remains the same.) In this way, the user is able to configure a complex pipe system 11 (e.g. FIG. 10), and never be left wanting for an angled joint having exactly the desired deflection angle.

Thus, there is described a novel and useful configuration and method for a variable angle joint to be used in conjunction with a piping system. Although preferred illustrative variations of the present invention are described above, it will be apparent to those skilled in the art that various changes and modifications may be made thereto without departing from the invention. For example, in another embodiment of the clasps, FIG. 7B shows how clasps may be connected by an alternative configuration in which opposing clasps 16, 18 each have a first detent 26′ and a second detent 28′ which are somewhat different to the embodiment in FIG. 7A (In FIG. 7B, only one first detent and one second detent are shown.) The first detent 26′ has a first male tooth 32′ having a first length and a first female receiver 35′. The second detent 28′ has a second male tooth 33′ having a second length and a second female receiver 34′. The first male tooth 32′ is configured to mate with the second female receiver 35′ when the clasps are initially engaged, to produce a set of clasps 16, 18 having a first overall circumference. The user may then press the two sets of detents 26′, 28′ closer together so that the second male tooth 33′ is received by the first female receiver 33′. At this stage, the clasps have a second overall circumference that is smaller than the first overall circumference. This result may be achieved by selecting a first length for the first male tooth 32′ that is longer than the second length of the second male tooth 33′.

It is intended that the appended claims cover all such changes and modifications that fall within the true spirit and scope of the invention.

We claim:

1. An angled joint for insertion into a pipe system comprising:
a first conduit having a first elongate axis and being configured to terminate in a planar section that is angled at 45 degrees to the first elongate axis, the planar section including a continuous circumferential first flange that extends outwardly from the first conduit;
a second conduit having a second elongate axis and being configured to terminate in a planar section that is angled at 45 degrees to the second elongate axis, the planar section including a continuous circumferential second flange that extends outwardly from the second conduit;
a first clasp that extends in a semi-annular configuration, and terminating in a first type detent on a first end and a second type detent on a second end, the first clasp having a sectional shape that defines a first channel extending along an inner surface of the first clasp;
a second clasp that extends in a semi-annular configuration, and terminating in a first type detent on a third end and a second type detent on a fourth end, the second clasp having a sectional shape that defines a second channel extending along an inner surface of the second clasp;
wherein:
the first flange is placed adjacent the second flange;
the first channel receives a portion of the first flange and a portion of the second flange; and
the second channel receives a portion of the first flange and a portion of the second flange;
the second type detent of the first clasp receives the first type detent of
the second clasp, and the second type detent of the second clasp receives the first type detent of the first clasp.

2. The angled joint of claim 1, wherein the first type detent on each clasp has at least a first tooth and a second tooth and the second type detent on each clasp has at least a first tooth and a second tooth; wherein,
when the first tooth of each first type detent engages the first tooth of each second type detent, then the first clasp and the second clasp together form an annulus having a first circumference; and
when the first tooth of each first type detent engages the second tooth of each second type detent, then the first clasp and the second clasp together form an annulus having a second circumference that it smaller than the first circumference.

3. The angled joint of claim 2, wherein when the first clasp and the second clasp have a first circumference, the first conduit and the second conduit may be rotated in relation to each other.

4. The angled joint of claim 1, wherein the first type detent on each clasp has a first male tooth and a first female receiver and the second type detent on each clasp has a second male tooth and a second female receiver; wherein,
when the first male tooth of each first type detent engages the second female receiver of each second type detent, then the first clasp and the second clasp together form an annulus having a first circumference; and
when the second male tooth of each second type detent engages the first female receiver of each first type detent, then the first clasp and the second clasp together form an annulus having a second circumference that it smaller than the first circumference.

5. The angled joint of claim 4, wherein when the first clasp and the second clasp have a first circumference, the first conduit and the second conduit may be rotated in relation to each other.

6. The angled joint of claim 1, wherein the first channel and the second channel each have side surfaces that define an internal taper.

7. The angled joint of claim 6, wherein the taper has an internal angle of between 1 degree and 10 degrees.

8. The angled joint of claim 1, wherein, the first flange and the second flange are configured such that, when the first flange and the second flange are placed in contact with each other, then opposite external surfaces of the flanges form an external taper.

9. The angled joint of claim 8, wherein the taper has an angle of between 1 degree and 10 degrees.

10. A kit for forming an angled joint for insertion into a pipe system comprising:
a first conduit having a first elongate axis and being configured to terminate in a planar section that is angled at 45 degrees to the first elongate axis, the planar section including a continuous circumferential first flange that extends outwardly from the first conduit;
a second conduit having a second elongate axis and being configured to terminate in a planar section that is angled at 45 degrees to the second elongate axis, the planar section including a continuous circumferential second flange that extends outwardly from the second conduit;
a first clasp that extends in a semi-annular configuration, and terminating in a first type detent on a first end and a second type detent on a second end, the first clasp having a sectional shape that defines a first channel extending along an inner surface of the first clasp;
a second clasp that extends in a semi-annular configuration, and terminating in a first type detent on a third end and a second type detent on a fourth end, the second clasp having a sectional shape that defines a second channel extending along an inner surface of the second clasp;
wherein:
the first flange is sized to be placed adjacent the second flange such that the first flange and second flange are in contact with each other along a full circumference;
the first channel is configured to receive a portion of the first flange and a portion of the second flange; and
the second channel is configured to receive a portion of the first flange and a portion of the second flange;
the second type detent of the first clasp is configured to receive the first type detent of the second clasp, and the second type detent of the second clasp is configured to receive the first type detent of the first clasp.

11. The kit of claim 10, wherein the first type detent on each clasp has at least a first tooth and a second tooth and the second type detent on each clasp has at least a first tooth and a second tooth; wherein,
when the first tooth of each first type detent engages the first tooth of each second type detent, then the first clasp and the second clasp together form an annulus having a first circumference; and
when the first tooth of each first type detent engages the second tooth of each second type detent, then the first clasp and the second clasp together form an annulus having a second circumference that it smaller than the first circumference.

12. The kit of claim 11, wherein when the first clasp and the second clasp have a first circumference, the first conduit and the second conduit may be rotated in relation to each other.

13. The kit of claim 10, wherein the first type detent on each clasp has a first male tooth and a first female receiver and the second type detent on each clasp has a second male tooth and a second female receiver; wherein,
when the first male tooth of each first type detent engages the second female receiver of each second type detent, then the first clasp and the second clasp together form an annulus having a first circumference; and
when the second male tooth of each second type detent engages the first female receiver of each first type detent, then the first clasp and the second clasp together form an annulus having a second circumference that it smaller than the first circumference.

14. The kit of claim 13, wherein when the first clasp and the second clasp have a first circumference, the first conduit and the second conduit may be rotated in relation to each other.

15. The kit of claim 10, wherein the first channel and the second channel each have side surfaces that define an internal taper.

16. The kit of claim 15, wherein the taper has an internal angle of between 1 degree and 10 degrees.

17. The kit of claim 10, wherein, the first flange and the second flange are configured such that, when the first flange and the second flange are placed in contact with each other, then opposite external surfaces of the flanges form an external taper.

18. The kit of claim 17, wherein the taper has an angle of between 1 degree and 10 degrees.
